(19) United States
(12) Patent Application Publication
(10) Pub. No.: US 2021/0142285 A1
(43) Pub. Date: May 13, 2021

(54) METHOD AND SYSTEM FOR AUTOMATICALLY PREPARING DOCUMENTATION

(71) Applicant: CLAAS KGaA mbH, Harsewinkel (DE)

(72) Inventors: Kevin Ueckert, Münster (DE); Janina Amsbeck, Georgsmarienhütte (DE)

(73) Assignee: CLAAS KGaA mbH, Harsewinkel (DE)

(21) Appl. No.: 17/090,119

(22) Filed: Nov. 5, 2020

(30) Foreign Application Priority Data
Nov. 7, 2019 (DE) DE102019130090.8
Nov. 7, 2019 (DE) DE102019130091.6

(51) Int. Cl. G06Q 10/10; G06F 16/28; G06Q 50/02; G07C 5/08; G06Q 30/02; G06Q 30/04; G06N 20/00

(52) U.S. Cl. CPC G06Q 10/10; G06F 16/285; G06Q 50/02; G06N 20/00; G06Q 30/0205; G06Q 30/04; G07C 5/0841

(57) ABSTRACT

A method and device for automatic preparation of documentation for an agricultural production machine is disclosed. Work of the agricultural production machine is documented in the documentation, whereby a positioning system records a movement path of the agricultural production machine while the work is being performed. The movement path, including position data and a timestamp assigned to the particular position data, is generated. The movement path is analyzed using data analysis to derive a movement pattern of the agricultural production machine, with the type of work of the agricultural production machine being inferred from the movement pattern. The data analysis may comprise a machine learning method, with the machine learning method including a classification step, a clustering step and a regression step.

### CROSS REFERENCE TO RELATED APPLICATIONS

This application claims priority under 35 U.S.C. § 119 to German Patent Application No. DE 102019130091.6 (filed Nov. 7, 2019) and to German Patent Application No. DE 102019130090.8 (filed Nov. 7, 2019), the entire disclosure of both of which are hereby incorporated by reference herein.

### TECHNICAL FIELD

The invention relates to the automatic preparation of documentation for the work of an agricultural production machine. “Agricultural production machines” include, but are not limited to, self-propelling agricultural production machines such as tractors, combines and forge harvesters.

### BACKGROUND

Documenting work processes in agriculture is of increasing importance. This is due to several reasons. For example, documentation may be used to monitor activity of individual employees, such as in the context of a large companies with many employees. As another example, documentation may be needed to meet various legal requirement of verifying actions of a respective farmer, such as with regards to monitoring fertilizer use and crop protection.

Documentation systems are disclosed in DE102014108644A1, DE102017105493A1, and not previously published DE 102019125507A1. Documentation is typically manually based in which the operator must still manually document a great amount of data, which is both time-consuming and error prone. Other methods may automatically create a posting for documentation. However, the automatic posting may be limited in its scope and application.

### DISCRIPTION OF THE FIGURES

The present application is further described in the detailed description which follows, in reference to the noted plurality of drawings by way of non-limiting examples of exemplary implementation, in which like reference numerals represent similar parts throughout the several views of the drawings, and wherein:

FIG. 1 shows a schematic representation of the method according to the invention.

FIG. 2 shows a flowchart of the method according to the invention.

FIG. 3 shows a flowchart of a detail of the method according to the invention.

FIG. 4 shows a detailed representation of the overall method, including the associated devices.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

As discussed in the background, the not previously published DE 102019125507A1 discloses automatically creating a posting for documentation. Automatically creating the posting may identify a path of movement based on GPS data and the time information, and wherein additional work data are assigned to this recorded movement path. The work data detected while performing the work may be classified according to the type of work performed, and the classes of the performed work may then be automatically inserted into the documentation posting. In particular, this has the effect that the posting system functions very precisely since it may access a great deal of work data, wherein this work data may, in particular, be any one, any combination, or all of: the positions of a large number of fields; a location category for a large number of locations; the type of cultivated crop on at least one field; or the class of at least one job performed earlier on at least one field.

However, if such data does not exist or only exists to an insufficient extent, or if such data must be obtained from specific data sources, such a posting system requires, at a minimum, additional effort to obtain and compile the data.

Thus, in one or some embodiments, a system and method is disclosed that at least partly automates the creation of a posting for documentation wherein work of an agricultural production machine is documented in the documentation and wherein a positioning system records a movement path of the agricultural production machine while the work is being performed. In particular, in order to generate the movement path, one or both of position data or a timestamp (such as at least both of the position data and the timestamp) assigned to the particular position data are available. Further, the movement path is analyzed in order to derive at least one or more aspects of the operation of the agricultural production machine, such as one or more aspects of the movement path and/or one or more aspects of the operation of the agricultural production machine. For example, the movement path may be analyzed in order to infer, derive or determine a movement pattern of the agricultural production machine, and in turn the type of work of the agricultural production machine may be inferred, derived or determined from the movement pattern. In one or some embodiments, the data analysis may at least partly be performed by a machine learning method, with the machine learning method comprising any one, any combination, or all of: a classification step; a clustering step; and a regression step (such as at least each of the classification step, the clustering step, and the regression step optionally in such a sequence). In this way, the preparation of the documentation posting may be largely automated.

As discussed above, the machine learning may include one, some, or all of the classification step (which includes executing at least one classification algorithm), the clustering step (which includes executing at least one clustering algorithm), and the regression step (which includes executing at least one regression algorithm). In one or some embodiments, since the classification step includes at least one classification algorithm. The classification algorithm allows at least one classification according to field travel and road travel, the GPS-based location points of the movement path may be clearly assigned to either road travel or travel on a field.

In one or some embodiments, since the clustering step includes at least one clustering algorithm, wherein the clustering algorithm enables at least a distinction between fields, the field travel location points identified in the classification algorithm may be assigned to certain fields.

In one or some embodiments, since the regression step includes at least one field border identification algorithm, where the field border identification algorithm includes at least the identification of field borders, the fields identified in the cluster algorithm may be assigned specific field borders.

In one or some embodiments, the position data and the timestamp comprising the time information may be generated by a cellular phone carried in the agricultural production machine (such as physically associated in or on or within the agricultural production machine). In this way, the cellular phone that the operator already carries may process the intended method without the operator being involved in this process.

In one or some embodiments, the position data are generated by a GPS receiver that is available in many typical cellular phones and is also widespread in agricultural production machines. In this way, the GPS receiver may access the Global Positioning System (GPS), which may include the global navigation satellite systems, that provide geolocation and time information, which are examples of GPS data.

In one or some embodiments, to enable inferring a movement pattern of an agricultural production machine and/or the type of activity that it is performing solely from GPS data, the data are analyzed using a computerized method using artificial intelligence to derive the movement pattern and the type of activity.

In this context, in a specific embodiment, one method results when, in an advantageous development, at least one trainable machine learning method and parameter dependencies saved in characteristic curves are available in the method for using artificial intelligence.

In one or some embodiments, the classification algorithm, the cluster algorithm and the field boundary identification algorithm are combined with each other, wherein the combination is structured so that the weaknesses of a preceding algorithm are compensated by a following algorithm. This has the effect that the assignment of location points to a specific field or road travel becomes increasingly precise from algorithm to algorithm.

This effect may further be enhanced in that, in another embodiment of the invention, key indicators are derived from the position data and the timestamps comprising the time information, and the derived key indicators help differentiate the location points within an algorithm.

The procedure, in particular the precision of the methodology disclosed, may also be further enhanced in that at least one of the algorithms, such as any one, any combination, or all of the classification algorithm, the cluster algorithm or the field boundary identification algorithm, uses a cost function, and the cost function is specifically structured for each application (e.g., for the respective algorithm to which the cost function is applied).

In one or some embodiments, the data analysis may take into account other machine and/or use-specific parameters in addition to the position data and the timestamps comprising the time information. In particular, this has the effect that the information generated by the method may be evaluated so that the user may use the data in a more versatile manner.

Since the movement pattern derived from the data analysis enables automatic recognition of the field boundaries, this ensures that the user of the data receives precise information on the geometry of the particular field, such as the part of the field being traversed by the agricultural production machine.

In one or some embodiments, the results of the data analysis may be exported or used by other systems, such as exporting at least the automatically recognized field boundaries to external data processing systems, such as external farm management software systems. In this way, deployment plans for following machines, so-called route plans, may be created based on this exported data. Further, the data may be exported responsive to generating the results of the data.

Moreover, the methodology may evaluate one or more aspects of the machine operating efficiency, which may be derived from the movement patterns (which itself may be derived through the data analysis). Various aspects of the machine operating efficiency are contemplated, including any one, any combination, or all of: determining the process time; determining the downtime; or determining a transit time.

In one or some embodiments, the type of work of the agricultural production machine may be derived from the movement pattern of the agricultural production machine and used for preparing documentation. In this way, it is possible to document the work of an agricultural production machine in a straightforward manner. In this context, it is particularly advantageous when preparing the documentation includes automatically preparing an invoice.

In one or some embodiments, the result or the results of the data analysis, such as the identified movement pattern and/or the identified type of work of the agricultural production machine, are transmitted to one or more farm management systems, thereby allowing for a high degree of flexibility in the subsequent use of the data.

In one or some embodiments, a device for performing the method discussed above is disclosed. In particular, the device is configured to automatically prepare documentation, and to document work of an agricultural production machine in the automatically prepared documentation. The device may include a positioning system device (such as a GPS receiver) that records a movement path of the agricultural production machine using work data while the work is being performed. The movement path may be generated based on one or both of position data and a timestamp assigned to the particular position data. The device may further analyze the movement path in order to derive one or more aspects of the movement path and/or operation of the agricultural production machine, including one or both of deriving, using data analysis and from the movement path, a movement pattern of the agricultural production machine or inferring the type of work of the agricultural production machine from the movement pattern. The data analysis performed by the device may at least partly comprise a machine learning method, with the machine learning method including any one, any combination, or all of: a classification step; a clustering step; and a regression step (such as each of the classification step, the clustering step and the regression step).

Referring to the figures, FIG. 1 shows an agricultural production machine 1, such as a tractor, with a field sprayer as an attachment 2. The tractor is merely provided by way of example. Other agricultural production machines are contemplated. The tractor and attachment may exchange information through a communication bus. The agricultural production machine 1 is equipped with a positioning system 3. The positioning system 3 is designed according one embodiment of the invention as a cellular phone 4 (which includes a GPS receiver and communication functionality, such as cellular communication functionality) and is either permanently assigned to the agricultural production machine 1, or is carried by an operator 5 of the agricultural production machine 1. The cellular phone 4 comprising the positioning system 3 is assigned an application module 6, which is described in detail below, and records a movement path 7 at least partly while the work of the agricultural production machine 1 is being performed (such as coextensive in time with operation of the agricultural production machine 1). The movement path 7 comprises a sorted list of location points 8. Each location point 8 indicates a location in the form of position data 9 and is recorded with a timestamp 10. The location points 8 of the movement path 7 represent work data 11.

The work data 11 are either processed directly in the application module 6 of the cellular phone 4 in a manner according to the invention which will be described further, or are forwarded to a receiving station 13 via a mobile communications link 12 for processing by an electronic device external to cellular phone 4. The work data 11 may be forwarded from the receiving station 13 through a network 14, such as the Internet, to a computer system 15. Computer system 15 may include at least one processor and at least one memory. Likewise, cellular phone 4 may include at least one processor (shown as element 64 within data analysis 17) and at least one memory. Various ways are contemplated to manifest the processor/memory in the computer system 15 and the cellular phone 4. As one example, in the computer system 15, data analysis 17 comprises the at least one processor, and database 16 comprises the at least one memory (in which to store data (and optionally to store one or more executable programs executed by the processor)). As another example, in the cellular phone 4, data analysis 17 comprises the at least one processor (as shown at element 64), and work data 11 comprises the at least one memory (in which to store data (and optionally to store one or more executable programs executed by the processor)).

Thus, the data analysis 17 may comprise any type of computing functionality and may include a processor and a memory, which may be resident therein. The processor (which may comprise a microprocessor, controller, PLA or the like) and the memory may comprise separate elements, or may be part of a single machine, which includes a microprocessor (or other type of controller) and a memory unit. The microprocessor and memory unit are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, circuitry associated with data analysis 17, may store in or access instructions from memory for execution, or may implement its functionality in hardware alone. The instructions, which may comprise computer-readable instructions, may implement the functionality described herein (such as the data analytics) and may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described herein or illustrated in the drawings. Thus, data analytics 17 may access data, which may be stored in work data 11 or in database 16, in order to perform the data analytics discussed herein.

Thus, analogous to a processor in combination with the application module 6 of the cellular phone 4, the computer system 15 may then process the work data 11 in a manner to be described in greater detail. The data analysis 17 of the work data 11 then occurs either directly in the application module 6 of the cellular phone 4, or in the external computer system 15. Proceeding from this data analysis 17, the application module 6 or the external computer system 15 then creates the documentation 18 as described in greater detail below. Then, the computer system 15 or the application module 6 may create a documentation posting 19 to be described in greater detail, which may then be posted in a documentation recording system 20.

The recorded movement path 7 may comprise the movement of the agricultural production machine 1 on a plurality of fields 21, 22, on a path to a farm 23 or an intermediate goal 24 such as a transport trailer or a storage site.

FIG. 2 is a first example flowchart of schematically describing the methodology. By incorporating the positioning system 3 assigned to the cellular phone 4, the application module 6 generates the position data 9 and the timestamp 10 assigned to the particular position data 9, wherein each data pair 9, 10 represents a location point 8 of the movement path 7 of the agricultural production machine 1 during the work of the agricultural production machine 1. The movement path 7 resulting from the location points 8 is subjected to the previously mentioned data analysis 17 at 25. The result of the data analysis 17 is thus the derivation of a movement pattern 26 of the agricultural production machine 1. At 27, the type of work 28 of the agricultural production machine 1 is deduced from the derived movement pattern 26. Finally, the determined type of work 28 of the agricultural production machine 1 is used to create documentation 18 at 29 to be described in greater detail, which may then be used to initiate a documentation posting 19.

In the simplest case, the positioning system 3 generating the position data 9 and the timestamp 10 may be configured as a GPS receiver 30.

In one or some embodiments, the data analysis 17 used to determine the movement pattern 26 according to FIG. 3 comprises a computerized method 31 that comprises artificial intelligence 32, described in greater detail below, for deriving the movement pattern 26. In a practical implementation, the computerized method 31 comprising the artificial intelligence 32 is formed from a combination of a trainable machine learning method 33 and parameter dependencies 35 saved in characteristic curves 34. In one or some embodiments, the machine learning method comprises any one, any combination, or all of: a classification step 58; a clustering step 59, and a regression step 60. In a specific embodiment, the machine learning method 33 comprises the classification step 58 (which may include a classification algorithm 36), the clustering step 59 (which may include a cluster algorithm 37), and the regression step 60 (which may include a field boundary identification algorithm 38). The classification algorithm 36 is configured such that the location points 8 representing the movement path 7 are classified according to field travel 39 and road travel 40. The cluster algorithm 37 is structured at least so that the location points 8 representing the field travel 39 are then assigned to specific fields 21, 22 so that a distinction between fields 21, 22 is possible. The field boundary identification algorithm 38 is finally configured such that the field boundaries 41 of the fields 20, 21 identified using the cluster algorithm 37 are determined.

FIG. 4 describes the method according to one or some embodiments in detail. As previously described, through a positioning system 3 attached to or associated with the agricultural production machine 1, a communication module 42 or a cellular phone 4, the agricultural production machine 1 generates position data 9 and a timestamp 10 that represent the position and time of measurement of the particular location point 8. The position data 9 may be composed of the geographic longitude and latitude so that the work data 11 form a raw data set 43 that comprises the longitude, the latitude and the timestamp 10 of the particular location point 8. Key indicators 45 may be calculated in a first processing step 44 based on this raw data 43. This procedure may also be termed a feature engineer. In one or some embodiments, this step 44 is necessarily performed since it may not be possible, solely on the basis of the raw data 43, to identify patterns in data by whatever structure using the classification algorithm 36 or the cluster algorithm 37.

In one or some embodiments, key indicators 45 such as the speed 45a and the traveled path 45b of the agricultural production machine 1 from one location point 8 to the next are determined from the raw data 43 in the first processing step 44. In addition, the moving averages of these calculated key indicators 45 are calculated with episodes 5, 10, 15, 20, . . . , 95, 100, wherein “episode” may be understood to be the averages of the last 5, 10, 15, 20, . . . , 95, 100, calculated key indicators 45. Other “episodes” are contemplated. The angle 45c is determined as another key indicator 45 with which the agricultural production machine 1 is moved from one location point 8 to the next. Moreover, the average distance 46 from the 5, 10, 15, . . . , 145, 150 closest location points 8 is determined in order to draw a circle 47 around each location point 8 with an optional radius of 50, 55, 60, . . . . , 95, 100 m. Then, the circle 47 may be divided, such as into 4 quadrants 48. The number of additional location points 8 is determined per quadrant 48. Thus, the key indicators may be derived from the raw data 43 generated by positioning system 3.

Then, using the machine learning method 33, and the generated raw data set 43, and the determined key indicators 45, the classification algorithm 36 is trained, which assigns field travel 39 or road travel 40 to the respective location point 8.

To train the classification algorithm 36, examples may initially be presented to the algorithm, (e.g., data records 49 that have already been categorized as road travel 40 and field travel 39). The assignment of raw data 43 to categories is termed “labeling” and generally is done manually (e.g., in order to perform supervised machine learning). Each location point 8 may therefore be first manually assigned by a human to road travel 40 or field travel 39. The training data record 50 may be composed of this classification and the calculated values, the key indicators 45. The classification algorithm 36 may be trained based on the training data record 50 so that it is capable of classifying data records (such as work data 11) without human intervention as road travel 40 and field travel 39. A validation data record 50′ may be formed from 30% of the training data record 50 in a manner known to one of skill in the art, which will therefore not be explained in detail here. The parameters of the algorithm XGBoost used here in the typical manner are determined with the assistance of the remaining training data record 50. The so-called hyperparameters are determined with the assistance of the validation data record 50′ and the grid search method used here in the typical manner. After the conclusion of this training phase, the classification algorithm 36 is capable of classifying the location points 8 of a movement path 7 as location points 8 of road travel 40 and location points 8 of field travel 39. In particular, after training, the classification algorithm 36 may determine, based on raw data and/or key indicators 45 input, whether the data is indicative of whether the agricultural production machine 1 should be classified as traveling on a field or traveling on a road. Other classifications are contemplated.

Then, with the exclusion of those location points 8 that were classified as road travel 40, calculations which will be described in greater detail are performed, which enables the described cluster algorithm 37 to distinguish between different fields 21, 22, 22n. In particular, a subset of the location points 8 that are identified as being directed to a field (based on the classification), which excludes the location points 8 that were identified as being directed to the road (based on the classification), may be used in the cluster algorithm 37 (thereby improving operation of the cluster algorithm 37 in order to assign the subset of the location points 8 that are identified as being directed to a field to a respective one of the fields. In this way, one, some, or all location points 8 classified as field travel 39 are assigned to a field 21, 22, 22n by the cluster algorithm 37.

Analogous to the classification algorithm 36, other calculations may be performed that allow the cluster algorithm 37 to distinguish between fields 21, 22, 22n. To accomplish this, various calculations known to one of skill in the art and not described here in further detail are taken into consideration including any one, any combination, or all of: the so-called centroid 61; the center of all location points 8 of a cluster; the distance of each location point 8 of a cluster to the centroid 61; the calculation of the angle from a location point 8 to the next location point 8; and assignment of the determined angle to classes such as (0°-45° and 180°-225°), (45°-90° and 225°-270°), (90°-135° and 270°-315°) and (135°-180° and 315°-360°). Moreover, the difference in time of each location point 8 in seconds to the first location point 8 is determined. In addition, a field 21, 22, 22n with the structure “location points in the form of a field” is artificially generated and added to the data set for process clustering. If only one field 21, 22, 22n was worked on a day, it may be difficult for cluster algorithms 37 to recognize this since a distance to another point cluster cannot be determined. By generating an artificial field 21, 22, 22n, this failing may be circumvented. Cluster algorithms 37 that may be used are HDBSCAN or kMeans. Other cluster algorithms 37 are contemplated. After the cluster algorithm 37 has finished, the location points 8 of a movement path 7 have each been categorized as location points 8 of a particular field 21, 22, 22n, wherein the outer contour 51 of the particular field 21, 22, 22n is still fuzzy.

In the following step, the real field boundaries 41 are then determined by the field boundary identification algorithm 38. The starting point for this is the particular outer contour 51 that is described by the particular polygon 52 in the depicted exemplary embodiment that encloses the related location points 8.

Whereas the cluster algorithm 37 assigns each location point to a cluster (e.g., a first cluster is associated with field 21, a second cluster is associated with field 22, an “n” cluster is associated with field 22n; whereby the cluster algorithm 37 assigns each location point to one cluster), it is the goal of the field boundary identification algorithm 38 to recognize the real field boundaries 41 of the particular field 21, 22, 22n (e.g., its concave envelope), that encloses the location points 8 of a cluster associated with one of the particular fields 21, 22, 22n. To accomplish this, a mathematical method known to one of skill in the art may be used which employs a parameter alpha 62 to determine the optimum concave envelope. This may be optimized by a genetic algorithm using the so-called cost function 63. The cost function 63 comprises (or consists of) 2 components: (1) the difference between the conclave and convex envelope (diff); and (2) the number of points of a cluster that lie within the concave envelope (pointsinconcave). The algorithm may minimize the cost function 63. One example of minimization of the cost function may use the below equation:

cost=diff+(pointsinconcave*0.9)

Algorithms from the field of machine learning may be imprecise. For example, the classification algorithm 36 may only achieve a precision of approximately 93%. For the present situation, this means that location points 8 may also be incorrectly classified or assigned to the wrong cluster. To determine the field boundaries 41, some location points 8 may be excluded from the above-described calculation method. In one or some embodiments, the exclusion of location points 8 may be an iterative process. In particular, the midpoint of the current envelope and the location points 8 are determined. Then the vector and the distance between the midpoints are calculated. The point at the outermost edge in the direction of the vector is removed. As a result, the midpoints come closer together. If this is the case, location points 8 are removed according to the same method until the midpoints are nearly next to each other.

Both the identification of the centroid 61 as well as the determination of the parameter alpha 62 may ultimately have the effect that a location point 8 can initially be precisely assigned to a field 21, 22, 22n, and then a more precise determination of the outer contour 51 of the particular field 21, 22, 22n is possible. In this way, the field boundary identification algorithm 38 may improve on the results from one or both of the classification algorithm 36 or the cluster algorithm 37.

As a result, the field boundary identification algorithm 38 may identify the actual field boundary 41 of the particular field 21, 22, 22n from the polygon 52 describing the outer contour 51 by means of this exclusion method. In this manner, it may ultimately be ensured that the movement pattern 26 derived from the data analysis 17 enables the automatic recognition of the field boundaries 41. Moreover, the method may be configured so that at least the identified field boundaries 41 may be exported to external data processing systems 53, such as external farm management software systems 54. Moreover, the results of the data analysis 17, such as at least the identified movement pattern 26 and the identified type of work 28 of the agricultural production machine 1, may be transmitted to the farm management software system 54.

If the field boundaries 41 are identified, it is contemplated that additional key indicators 55 may be derived therefrom. These may, for example, comprise one, some, or all of the following key indicators 55: the total travel time of the agricultural production machine 1; its actual work time on a field 21, 22, 22n; the accrued transport and/or transfer times such as road travel 40; the number of worked fields 21, 22, 22n; the size of the particular field 21, 22, 22n; the average driving speed of the agricultural production machine 1; the driving speed per field 21, 22, 22n; the work time per field 21, 22, 22n; and downtimes. These key indicators 55 may be generated by one of the cellular phone 4 or the computer system 15, and may also be provided to the external data processing systems 53 and farm management software systems 54.

Moreover, the identified field boundaries 41 may be used to query publicly available data 56, for example from the Sentinel satellite. This publicly available data 56 may, for example, be biomass data. The type of crop may then be derived from the information on the season (such as weather data), the biomass, the machine type and the particular position of the agricultural production machine 1, the particular location point 8. In turn, the particular work process may be derived from any one, any combination, or all of the following information: the type of crop; the season; the position; the machine type; and the average speed of the agricultural production machine 1. On the basis of the satellite data (or other type of publicly available data 56), a forecast of the yield of the particular field 21, 22, 22n may be calculated, and/or for example fertilization and watering recommendations may be derived.

In this manner, evaluation of one or more aspects of efficiency associated with the agricultural production machine 1 may be determined based on analysis of the movement patterns 26, which may be derived from the data analysis 17. The one or more aspects of efficiency may include any one, any combination, or all of: the determination of the process time; the determination of the downtime; or the determination of a transit time.

It is further contemplated that any or all of the above-described derived information may be provided to the one or more external data processing systems 53 and the one or more farm management software systems 54.

Moreover, the type of work 28 of the agricultural production machine 1 may be derived in the described manner from the identified movement pattern 26 of the agricultural production machine 1 and documentation 18 may be prepared, wherein the created documentation 18 may comprise the automatic preparation of an invoice 57.

In this regard, the analysis may be used in order to modify operation of an agricultural production machine (such as the agricultural production machine that obtained the data or another agricultural production machine) and/or management of the fields in one or more aspects. Example aspects include any one, any combination, or all of: operation of the agricultural production machine 1 may be affected or modified based on one or more factors, such as the forecast of the yield of the particular field 21, 22, 22n, the efficiency determination (e.g., the determination of the process time; the determination of the downtime; or the determination of a transit time); or the like. Alternatively, or in addition, management of the fields themselves may be modified or controlled based on the analysis (e.g., fertilization and/or watering of the fields).

It is intended that the foregoing detailed description be understood as an illustration of selected forms that the invention can take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some or all of the steps in the disclosed method are performed using a computer so that the methodology is computer implemented. In such cases, the resulting physical properties model may be downloaded or saved to computer storage.

List of reference numbers

| | |
|---|---|
| 1 | Agricultural production machine |
| 2 | Attachment |
| 3 | Positioning system |
| 4 | Cellular phone |
| 5 | Operator |
| 6 | Application module |
| 7 | Movement path |
| 8 | Location points |
| 9 | Position data |
| 10 | Timestamp |
| 11 | Work data |
| 12 | Mobile communications link |
| 13 | Receiving station |
| 14 | Network |
| 15 | Computer system |
| 16 | Database |
| 17 | Data Analysis |
| 18 | Documentation |
| 19 | Documentation posting |
| 20 | Recording of documentation |
| 21 | First field |
| 22 | Second field |
| 22n | Field |
| 23 | Farm |
| 24 | Immediate goal |
| 25 | Following step |
| 26 | Movement pattern |
| 27 | Additional process step |
| 28 | Type of work |
| 29 | Additional process step |
| 30 | GPS |
| 31 | Computerized method |
| 32 | Artificial intelligence/AI |
| 33 | Machine learning method |
| 34 | Characteristic curves |
| 35 | Parameter dependencies |
| 36 | Classification algorithm |
| 37 | Cluster algorithm |
| 38 | Field boundary identification |
| | algorithm |
| 39 | Field travel |
| 40 | Road travel |
| 41 | Field boundary |
| 42 | Communication module |
| 43 | Raw data record |
| 44 | First processing step |
| 45 | Key indicator |
| 46 | Distance |
| 47 | Circle |
| 48 | Quadrant |
| 49 | data record |
| 50 | Training data record |
| 50′ | Validation data record |
| 51 | Outer contour |
| 52 | Polygon |
| 53 | Data processing system |
| 54 | Farmworker management software system |
| 55 | Key indicator |
| 56 | Publicly available data |
| 57 | Invoice |
| 58 | Classification step |
| 59 | Clustering step |
| 60 | Regression step |
| 61 | Centroid |
| 62 | Parameter alpha |
| 63 | Cost function |
| 64 | Processor |

1. A method for automatically preparing documentation documenting work of an agricultural production machine, the method comprising:
recording, using a positioning system, a movement path of the agricultural production machine while the work is being performed, the movement path comprising at least position data and a timestamp assigned to the position data;
analyzing, using data analysis, the movement path in order to derive a movement pattern of the agricultural production machine, wherein the data analysis is at least partly performed by a machine learning method; and
determining, based on the movement pattern, a type of work of the agricultural production machine.

2. The method of claim 1, wherein the machine learning method comprises at least a classification step, a clustering step, and a regression step.

3. The method of claim 2, wherein the classification step comprises using at least one classification algorithm; and
wherein the classification algorithm performs at least one classification according to field travel and road travel.

4. The method of claim 2, wherein the clustering step uses at least one clustering algorithm;
wherein a plurality of fields are available for differentiation through clustering; and
wherein, in performing the data analysis, the clustering algorithm performs clustering of data to one of the plurality of fields in order to perform at least one differentiation of fields.

5. The method of claim 2, wherein the regression step uses at least one field boundary identification algorithm; and
wherein the field boundary identification algorithm identifies field boundaries.

6. The method of claim 1, wherein the position data and the timestamp comprising time information are generated by a cellular phone associated with or carried in the agricultural production machine.

7. The method of claim 1, wherein the position data is generated by a GPS receiver.

8. The method of claim 1, wherein the data analysis comprises a computerized method for using artificial intelligence to derive the movement pattern.

9. The method of claim 8, wherein the computerized method for using the artificial intelligence comprises at least one trainable machine learning method and parameter dependencies saved in characteristic curves.

10. The method of claim 9, wherein the machine learning method uses at least one classification algorithm; and
wherein the classification algorithm performs at least one classification according to field travel and road travel.

11. The method of claim 9, wherein the machine learning method uses at least one clustering algorithm;
wherein a plurality of fields are available for differentiation through clustering; and
wherein, in performing the data analysis, the clustering algorithm performs clustering of data to one of the plurality of fields in order to perform at least one differentiation of fields.

12. The method of claim 9, wherein the machine learning method uses at least one field boundary identification algorithm; and
wherein the field boundary identification algorithm identifies field boundaries.

13. The method of claim 1, wherein the machine learning method comprises a classification algorithm, a clustering algorithm, and a field boundary identification algorithm; and
wherein a combination of the classification algorithm, the clustering algorithm, and the field boundary identification algorithm is structured so that weaknesses of a preceding algorithm are at least partly compensated by a following algorithm.

14. The method of claim 13, wherein the weakness of the classification algorithm is at least partly compensated by one or both of the clustering algorithm or the field boundary identification algorithm; and
wherein the weakness of the clustering algorithm is at least partly compensated by the field boundary identification algorithm.

15. The method of claim 13, wherein one or more key indicators are derived from the position data and the timestamps; and
wherein the one or more derived key indicators help differentiate location points of the agricultural production machine within one, some or each of the classification algorithm, the clustering algorithm, and the field boundary identification algorithm.

16. The method of claim 13, wherein at least one of the classification algorithm, the clustering algorithm, and the field boundary identification algorithm uses a cost function, and the cost function is specifically structured for a respective algorithm.

17. The method of claim 1, wherein the data analysis derives the movement pattern of the agricultural production machine from the movement path based on one or both of machine or use-specific parameters, the position data and the timestamps comprising time information.

18. The method of claim 1, further comprising automatically recognizing field boundaries based on the movement pattern.

19. The method of claim 18, further comprising exporting the automatically recognized field boundaries to one or more external farm management software systems.

20. The method of claim 1, further comprising evaluating, based on the movement pattern, at least one aspect of efficiency of the agricultural production machine; and
wherein the at least of efficiency of the agricultural production machine comprises at least one of process time, downtime, or transit time.

21. The method of claim 1, further comprising generating, based on the type of work inferred from the movement pattern, documentation for the agricultural production machine.

22. The method of claim 1, wherein generating the documentation for the agricultural production machine comprises automatically preparing an invoice.

23. The method of claim 1, further comprising transmitting at least the derived movement pattern and the determined type of work of the agricultural production machine to one or more farm management systems.

24. The method of claim 1, wherein the movement path is on a field; and
further comprising one or both of modifying operation of an agricultural production machine in one or more aspects or modifying management of the field in one or more aspects.

25. A device for automatically preparing documentation documenting work of an agricultural production machine, the device comprising:
a positioning system configured to record a movement path of the agricultural production machine while the work is being performed, the movement path comprising at least position data and a timestamp assigned to the position data;
at least one processor in communication with the positioning system, the at least one processor configured to:
access the movement path of the agricultural production machine;
analyze, using data analytics, the movement path in order to derive a movement pattern of the agricultural production machine, wherein the data analytics is at least partly performed by machine learning method; and
determine, based on the movement pattern, a type of work of the agricultural production machine.

26. The device of claim 25, wherein the machine learning method comprises at least a classification step, a clustering step, and a regression step.
